(19) United States
(12) Patent Application Publication
(10) Pub. No.: US 2024/0168280 A1
(43) Pub. Date: May 23, 2024

(54) CONDUCTIVE LIQUID FORMULATIONS FOR ELECTROWETTING OPTICAL DEVICES

(71) Applicant: CORNING INCORPORATED, CORNING, NY (US)

(72) Inventors: Jerome René Broutin, Bilieu (FR); Benjamin Jean-Baptiste Francois Burger, Lyon (FR); Frederic Jean Jacques Laune, Villefontaine (FR); Géraldine Denise Juliette Malet-Vasseur, Villeurbanne (FR)

(21) Appl. No.: 18/382,270

(22) Filed: Oct. 20, 2023

Related U.S. Application Data
(60) Provisional application No. 63/426,496, filed on Nov. 18, 2022.

(51) Int. Cl. G02B 26/00; G02B 3/14

(52) U.S. Cl. CPC G02B 26/005; G02B 3/14

(57) ABSTRACT

An electrowetting optical device includes a conductive liquid, a non-conductive liquid, and a substrate. The conductive liquid is buffered to an acidic pH. The conductive liquid and the non-conductive liquid are immiscible. The substrate includes a dielectric topcoat. The conductive liquid and the non-conductive liquid are in contact with the dielectric topcoat. The dielectric topcoat is a plasma-deposited organosilane precursor having the molecular formula SiOₓC_{y}H_{z}.

This application claims the benefit of priority under 35 U.S.C § 120 of U.S. Provisional Application Ser. No. 63/426,496 filed on Nov. 18, 2022, the content of which is relied upon and incorporated herein by reference in its entirety.

### BACKGROUND

The present invention generally relates to electrowetting optical devices. More specifically, the present invention relates to conductive liquid formulations for electrowetting optical devices.

### SUMMARY

According to one example, an electrowetting optical device includes a conductive liquid, a non-conductive liquid, and an insulating layer. The conductive liquid is buffered to an acidic pH. The conductive liquid and the non-conductive liquid are immiscible. The conductive liquid includes a buffer to control pH. The buffer includes an acid and its conjugate base. The insulating layer includes a base layer and a dielectric topcoat. The conductive liquid and the non-conductive liquid are in contact with the dielectric topcoat. The dielectric topcoat has the molecular formula SiOₓC_{y}H_{z}.

According to another example, an electrowetting optical device includes a conductive liquid, a non-conductive liquid, and a substrate. The conductive liquid is buffered to an acidic pH. The acidic pH to which the conductive liquid is buffered is in a range of about 3.0 to less than about 7.0. The conductive liquid includes a weak acid and a conjugate base of the weak acid. The weak acid and the conjugate base are each present in the conductive liquid at a concentration of between about 0.0010 mol/L to about 1.0 mol/L. The conductive liquid and the non-conductive liquid are immiscible and form a triple interface on a dielectric topcoat. The substrate includes the dielectric topcoat. The conductive liquid and the non-conductive liquid are in direct contact with the dielectric topcoat. The dielectric topcoat has the molecular formula SiOₓC_{y}H_{z}.

Additional features and advantages will be set forth in the detailed description, which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a cross-sectional view of an exemplary electrowetting optical device shown in a first state;

FIG. 2 is a simplified cross-sectional view of a variable-focus electrowetting optical device according to one embodiment;

FIG. 3 is a schematic representation of a natural contact angle and triple interface of a non-conductive liquid on a surface of an insulating substrate in the presence of a conductive liquid;

FIG. 4 is a graph that depicts hysteresis, in diopters, of an electrowetting optical device as a function of pH of a conductive liquid for a comparative example and one embodiment according to the present disclosure;

FIG. 5 is a graph that depicts optical power drift, in diopters, of the electrowetting optical device, before stabilization, when a voltage of 50 volts is applied, according to one embodiment;

FIG. 6 is a graph that depicts an evolution of stability, in diopters, of the electrowetting optical device, according to one embodiment, as a function of the pH of the conductive liquid when a voltage of 50 volts is applied;

FIG. 7 is a graph that depicts a stability after a thermal storage of comparative electrowetting optical devices and electrowetting optical devices according to embodiments of the present disclosure as a function of storage time at room temperature;

FIG. 8 is a graph that depicts hysteresis, in diopters, of an electrowetting optical device as a function of pH of a conductive liquid, according to one embodiment;

FIG. 9 is a graph that depicts optical power drift, in diopters, of a comparative electrowetting optical device and an electrowetting optical device according to one embodiment, before stabilization, when a voltage of 50 volts is applied; and

FIG. 10 is a graph that depicts optical power drift, in diopters, of a comparative electrowetting optical device and an electrowetting optical device according to one embodiment, before stabilization, when a voltage of 50 volts is applied.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

It is an object of the present disclosure to provide an electrowetting optical device that exhibits good optical quality and a low optical power shift when a voltage is applied. Additionally, it is an object of the present disclosure to provide the electrowetting optical device with stable optical performance over time and to prevent an increase in hysteresis of electrowetting optical device after storage for prolonged periods of time (aging). In a preferred embodiment, the electrowetting optical device is a liquid lens.

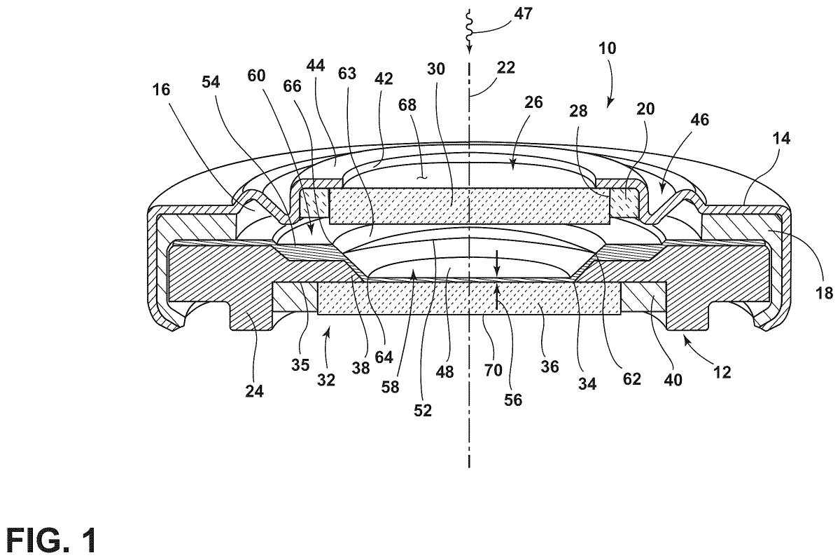

Referring now to FIG. 1, in embodiments, an electrowetting optical device is a liquid lens 10 that includes a base 12 and a cap 14. The base 12 and the cap 14 can be mounted relative to one another to facilitate maintenance of a fluid-tight containment region 16 to provide electrical insulation between the base 12 and the cap 14. A gasket 18 may be disposed between the base 12 and the cap 14 to facilitate maintenance of the fluid-tight containment region 16.

The liquid lens 10 includes a first electrode 20, an optical axis 22, and a second electrode 24. In embodiments, the liquid lens 10 is rotationally symmetric about the optical axis 22. The first electrode 20 and/or the second electrode 24 may include a conductor. In embodiments, the first electrode 20 and/or the second electrode 24 includes a metal, such as one or more of copper, silver, gold, platinum, aluminum, chromium, titanium, nickel, steel, bronze, and/or brass. In embodiments, the first electrode 20 and/or the second electrode 24 includes a conductive polymer, such as one or more of poly(3,4,-ethylenedioxythiophene) (PEDOT), polyphenylsulfide (PPS), PEDOT:PPS, poly-p-phenylene(PpP), polythiophene (PTh), polyanilines (PANI), polypyrrole (PPy), polyphthalocyanine (PPhc), or polyisothionaphthalene (PITN). In embodiments, the first electrode 20 and/or the second electrode 24 includes a material that is transparent over a desired operating wavelength range of the liquid lens 10. In embodiments, the second electrode 24 includes one or more of PEDOT, PEDOT:PPS, aluminum oxide, cadmium oxide, gallium oxide, tin oxide (e.g., indium tin oxide (ITO)), and zinc oxide. In embodiments, the first electrode 20 and/or second electrode 24 are doped with one or more transition metals and/or Group IIIA metals (e.g., aluminum, gallium, indium, thallium). In embodiments, the first electrode 20 and/or the second electrode 24 include an intrinsically conductive polymer (e.g., the bulk of the polymer is conductive). In embodiments, the first electrode 20 and/or the second electrode 24 includes a polymer composite that includes a polymer matrix with nanoparticles and/or carbon fiber incorporated therein.

In embodiments, the first electrode 20 circumscribes a first window 26 via a through aperture 28. In embodiments, the first window 26 further includes a first substrate 30. In embodiments, the first substrate 30 is mounted relative to the through aperture 28. In embodiments, the first substrate 30 is mounted entirely within the through aperture 28 of the first electrode 20, with the first electrode 20 entirely circumscribing the first substrate 30.

In embodiments, the second electrode 24 at least partially circumscribes a second window 32 via a through aperture 34 of the second electrode 24. In embodiments, the through aperture 34 of the second electrode 24 has a cross-sectional diameter in a direction perpendicular to the optical axis 22 that is stepped to define a seat 35. In embodiments, the second window 32 further includes a second substrate 36. In embodiments, the second substrate 36 is mounted relative to the corresponding through aperture 34. In embodiments, a portion 38 of the second electrode 24 extends over an outer circumferential portion of one or both major surfaces of the second substrate 36.

In embodiments, the second substrate 36 is mounted by a fitting 40 to the seat 35 of the through aperture 34. Furthermore, in embodiments, the base 12 includes the second electrode 24, the second window 32, and the fitting 40. In such embodiments, the gasket 18 provides a fluid seal between the second electrode 24 of the base 12 and the cap 14 to facilitate maintenance of the fluid-tight containment region 16.

In embodiments, the cap 14 includes or supports the first electrode 20 and the first window 26. In embodiments, the cap 14 defines an effective through aperture 42 that is smaller than a diameter of through aperture 28 of the first electrode 20, wherein a lip 44 extends over the outer surface of the first electrode 20 and over an outer peripheral portion of the first window 26 to protect the first electrode 20 and the interface between the first substrate 30 and the first electrode 20 from external forces and environmental conditions. Furthermore, the lip 44 extends over an outer peripheral surface of the first electrode 20 to further help protect the first electrode 20 from external forces and environmental conditions as well as help seat the first electrode 20 within a reception area of the cap 14. In embodiments, the cap 14 has a shape that is rotationally symmetric about the optical axis 22. In embodiments, as shown, the cap 14 has a substantially “S” shaped portion 46 that has bent portions with one bent portion having an opening facing the fluid-tight containment region 16 and another bent portion having an opening facing away from the fluid-tight containment region 16. The substantially “S” shaped portion 46 may allow some movement or resilience of the first substrate 30 along the optical axis 22 when pressure is exerted by the fluids (not shown for clarity) inside the fluid-tight containment region 16 of the liquid lens 10 and/or when pressure is externally exerted on the cap 14 of the liquid lens 10.

The optical axis 22 intersects both the first window 26 and the second window 32. In embodiments, as shown, the optical axis 22 passes through the center of both the first substrate 30 and the second substrate 36. In embodiments, the second window 32 is aligned with the first window 26 along the optical axis 22.

In embodiments, the thickness of first substrate 30 and second substrate 36 are such that transmittance of incident electromagnetic radiation 47 of the desired wavelength range through the first window 26 and the second window 32 into the fluid-tight containment region 16 or out of the fluid-tight containment region 16 is about 85% or more. Typical thicknesses of the first substrate 30 and the second substrate 36 are from 0.04 mm to 2.0 mm. In embodiments, the first substrate 30 and the second substrate 36 each has an average transmission over an operating wavelength range of the incident electromagnetic radiation 47 of about 85% or greater, about 88% or greater, about 90% or greater, about 92% or greater, about 94% or greater, about 96% or greater, about 98% or greater, or about 99% or greater. As used herein, transmittance refers to an arithmetic average (e.g., mean) percentage of normally incident intensity of the electromagnetic radiation 47 transmitted through a material or a device over the operating wavelength range. In embodiments, the operating wavelength range may be over visible optical wavelengths. In embodiments, the operating wavelength range may be over a range of wavelengths from about 400 nanometers (nm) to 700 nm, from about 400 nm to about 550 nm, from about 550 nm to about 700 nm, from about 600 nm to about 700 nm, or any range or subrange therebetween. In some embodiments, the operating wavelength range may be over infrared wavelengths, such as over a range of wavelengths from about 700 nm to about 1000 nm. In embodiments, the operating wavelength range may be over a range of ultraviolet wavelengths, such as over a range of wavelengths from about 10 nm to about 400 nm.

The first substrate 30 and/or the second substrate 36 can comprise a polymer, a crystalline material (e.g., quartz, sapphire, single crystal or polycrystalline alumina, spinel (MgAl₂O₄)), a glass-based material, or combinations thereof. Examples of suitable polymers include, without limitation, the following including copolymers and blends thereof: thermoplastics including polystyrene (PS), polycarbonate (PC), polyesters including polyethyleneterephthalate (PET), polyolefins including polyethylene (PE), acrylic polymers including polymethyl methacrylate (PMMA), epoxies, and silicones including polydimethylsiloxane (PDMS). As used herein, “glass-based” includes both glasses and glass-ceramics, wherein glass-ceramics have one or more crystalline phases surrounded by or dispersed within a glass phase. A glass-based material may include an amorphous material (e.g., glass) and optionally one or more crystalline materials (e.g., ceramic). Exemplary glass-based materials, which may be free of lithia or not, include soda lime glass, alkali aluminosilicate glass, alkali containing borosilicate glass, alkali aluminophosphosilicate glass, and alkali aluminoborosilicate glass.

The liquid lens 10 further includes a first liquid 48 and a second liquid 50 disposed within the fluid-tight containment region 16. The first liquid 48 may alternatively be referred to as a “non-conductive liquid” and the second liquid 50 may alternatively be referred to as a “conductive liquid”. An interface 52 is formed between the first liquid 48 and the second liquid 50. For example, in embodiments, the first liquid 48 and the second liquid 50 are immiscible. As used herein, “immiscible” means that when mixed together, the first liquid 48 and the second liquid 50 do not form a homogeneous solution so that the interface 52 forms. In the embodiment of FIG. 1, the first liquid 48 and the second liquid 50 are in direct contact and interface 52 corresponds to the region of contact of first liquid 48 with second liquid 50. The interface 52 forms a lens. In embodiments, the first liquid 48 and the second liquid 50 have substantially the same density, which can help to avoid changes in the shape of the interface 52 as a result of changing the physical orientation of liquid lens 10 (e.g., as a result of gravitational forces). The first liquid 48 and the second liquid 50 differ in density (at 20° C.) by less than 0.20 g/mL, or less than 0.15 g/mL, or less than 0.10 g/mL, or less than 0.05 g/mL, or in a range from 0.01 g/mL to 0.20 g/mL, or in a range from 0.05 g/mL to 0.15 g/mL In embodiments, the first liquid 48 has a refractive index n_{d} that is greater than a refractive index n_{d} of the second liquid 50. In embodiments, the difference between the refractive index n_{d} of the first liquid 48 and the refractive index n_{d} of the second liquid 50 is in a range from 0.02 to 0.24. In embodiments, the first liquid 48 has a refractive index n_{d} that is less than a refractive index n_{d} of the second liquid 50. In embodiments, the difference between the refractive index n_{d} of the second liquid 50 and the refractive index n_{d} of the first liquid 48 is in a range from 0.02 to 0.24.As used herein, n_{d} refers to refractive index at a wavelength of 587.56 nm at 20° C. The optical axis 22 passes through the interface 52.

In embodiments, the first liquid 48 is a non-conductive liquid. As used herein, the term “non-conductive liquid” refers to a liquid having a conductivity less than 1×10⁻³ Siemens per meter (S/m). In embodiments, the first liquid 48 is a non-polar liquid. Examples of the first liquid 48 include inorganic liquids (e.g., silicone oil), alkyl chain molecules (e.g., alkanes such as hexane, heptane, octane, nonane, decane, dodecane), aromatic compounds (e.g., benzene, toluene, diphenyldimethylsilane, 2-(ethylthio)benzothiazole, 1-chloronaphthalene, thionaphthene, 4-bromodiphenyl ether, 1-phenylnaphthalene, 2,5,-dibromotoluene, phenyl sulfide, fluorinated hydrocarbons, fluorinated silicones, germanium organometallic compounds (e.g., tetramethylgermane, tetraethylgermane, hexamethyldigermane, hexaethyldigermane, diphenyldimethylgermane, phenyltrimethylgermane), or combinations thereof.

In embodiments, the second liquid 50 is a conductive liquid. As used herein, the term “conductive liquid” refers to a liquid having a conductivity greater than 1×10⁻³ Siemens per meter (S/m). In embodiments, the second liquid 50 is a polar or ionic liquid. Examples of the second liquid 50 include water, alcohols (e.g., methanol, propanediols), glycols (e.g., ethylene glycol, propylene glycol, trimethylene glycol), ionic liquids (e.g., lithium carbonate, 1-ethyl-3-methylimidazolium-based, 1-alkylpyridinium-based, 1-butyl-3-methylimidazolium tetrafluoroborate-based, N-methyl-N-alkylpyrrolidinium-based liquids), inorganic ionic solutions (e.g., sodium phosphate, sodium bromide, sodium chloride, calcium chloride, lithium chloride, ammonium carbonate, ammonium tetrafluoroborate, potassium nitrate), organic ionic solutions (e.g., potassium acetate, acetic acid, succinic acid, iminodiacetic acid (IDA), nitrilotriacetic acid (NTA), ethylenediaminetetraacetic acid (EDTA), diethylene triamine pentaaectic acid (DTPA), ethylene glycol tetraacetic acid (EGTA), 1,2-bis(o-aminophenoxy)ethane-N,N,-N′N′-tetraacetic acid (BAPTA), 2,2′2″-(1,4,7,-triazonane-1,4,7,-triyl)triacetic acid (NOTA), 1,4,7,10-tetra-azacyclododecane-1,4,7,10-tetraacetic acid (DOTA)), and combinations thereof (e.g., 0.1 w/w potassium acetate in ethylene glycol). In embodiments, solutions containing inorganic or organic salts include a solvent. Solvents include polar liquids (e.g. water, alcohols, glycols).

The liquid lens 10 further includes an insulating layer 54. The insulating layer 54 covers the second window 32, the through aperture 34, and at least the portion of the second electrode 24 that defines the fluid-tight containment region 16. In embodiments, the insulating layer 54 further covers the portion of the second substrate 36 that the second electrode 24 does not cover. The insulating layer 54 has a thickness 56. In embodiments, the thickness 56 of the insulating layer 54 varies as a function of distance from the optical axis 22. The first electrode 20 is in electrical communication with the second liquid 50. The insulating layer 54 electrically insulates the first liquid 48 and the second liquid 50 from the second electrode 24. In embodiments, the insulating layer 54 is sufficiently transparent to enable transmission of the electromagnetic radiation 47 through the second window 32 as described herein. Additional aspects of the insulating layer 54 for purposes of this disclosure will be discussed further below.

Insulating layer 54 includes a dielectric topcoat disposed on a base layer. The base layer has a dielectric constant greater than about 3.0, or greater than about 5.0, or greater than about 10.0, or greater than 100, or in a range from 3.0 to 1000, or in a range from 5.0 to 500, or in a range from 10.0 to 300, or in a range from 20 to 200. Representative materials for the base layer include SiO₂, silicon oxynitride (SiOₓN_{y}), Si₃N₄, HfO₂, Y₂O₃, La₂O₃, TiO₂, Al₂O₃, Ta₂O₅, HfSiO₄, ZrO₂, ZrSiO₄, BaTiO₃, lead zirconate titanate (Pb(ZrₓTi₁₋ₓ)O₃), SrTiO₃, BaSrTiO₄, parylene C, parylene N, or mixtures thereof. The base layer has a thickness greater than 10 nm, or greater than 20 nm, or greater than 50 nm, or greater than 100 nm, or greater than 200 nm, or greater than 500 nm, or greater than 750 nm, or in a range from 10 nm to 1500 nm, or in a range from 10 nm to 1000 nm, or in a range from 10 nm to 750 nm, or in a range from 20 nm to 500 nm. The base layer can be formed using known techniques, such as PVD (physical vapor deposition), CVD (chemical vapor deposition), and plasma deposition.

The dielectric topcoat is an organosilicon material that includes Si, O, C, and H. The dielectric topcoat is formed from an organosilicon precursor. A variety of organosilicon precursors can be used to form the dielectric topcoat. Representative organosilicon precursors include siloxanes, silicon alkoxides, and silazanes, including organosilicon precursors having the formulas (R₃Si—[R₂Si]ₙ—R, R₃Si—X—SiR₃, and linear or cyclic variants of [—Si(R)₂X—]ₙ; where each X is independently O, NR′, or C(R″)₂; each R is independently H, C₁-C₆ alkyl, C₁-C₆ alkoxy, C₂-C₆ alkenyl, or phenyl; each R′ and R″ is independently H or C₁-C₆ alkyl; and each n is independently 0, 1, 2, or 3.

The dielectric topcoat has a thickness greater than 10 nm, or greater than 20 nm, or greater than 50 nm, or greater than 100 nm, or greater than 200 nm, or greater than 400 nm, or greater than 600 nm, or greater than 800 nm, or in a range from 5 nm to 1000 nm, or in a range from 5 nm to 800 nm, or in a range from 5 nm to 500 nm, or in a range from 5 nm to 250 nm, or in a range from 10 nm to 600 nm, or in a range from 10 nm to 400 nm, or in a range from 10 nm to 250 nm, or in a range from 10 nm to 150 nm.

The dielectric topcoat is formed from an organosilicon precursor through a plasma deposition process. PECVD (plasma enhanced chemical vapor deposition) is a preferred plasma deposition process. In one embodiment, the plasma deposition process is a plasma polymerization process. Subjecting the organosilicon precursor to a plasma deposition process produces a composition having the molecular formula SiOₓC_{y}H_{z}. The composition is typically non-stoichiometric. The coefficients x, y, and z depend on the selection of organosilicon precursor and the conditions used in the plasma deposition process, and are readily deduced after deposition by chemical analysis of the dielectric topcoat. Conditions used in the plasma deposition process include precursor flow rate, temperature, pressure, power applied to form the plasma, frequency, and the geometry of the deposition chamber.

The dielectric topcoat is preferably hydrophobic. As used herein, “hydrophobic” means that when contacted with water, the contact angle of the dielectric topcoat is greater than 90°.

In embodiments, the fluid-tight containment region 16 includes a first portion 58 (or base portion) proximate to insulating layer 54 and a second portion 60 (or headspace) proximate to substrate 30. In embodiments, at least a portion of the first liquid 48 is disposed in the first portion 58 of the fluid-tight containment region 16, while at least a portion of the second liquid 50 is disposed within the second portion 60 of the fluid-tight containment region 16. In embodiments, substantially all of the first liquid 48 is disposed within the first portion 58 of the fluid-tight containment region 16. In embodiments, a perimeter 62 of the interface 52 (e.g., the edge of the interface 52 in contact with insulating layer 54) is disposed within the first portion 58 of the fluid-tight containment region 16.

In embodiments, the fluid-tight containment region 16 (e.g., the first portion 58 of the fluid-tight containment region 16) is tapered along a sidewall 63 as shown in FIG. 1 such that a cross-sectional area of the fluid-tight containment region 16 decreases along the optical axis 22 in a direction from the first window 26 to the second window 32. For example, the first portion 58 of the fluid-tight containment region 16 includes a narrow end 64 and a wide end 66. The terms “narrow” and “wide” are relative terms, meaning the narrow end 64 is narrower, or has a smaller width or diameter, than the wide end 66. Such a tapered fluid-tight containment region 16 can help to maintain alignment of the interface 52 between the first liquid 48 and the second liquid 50 along the optical axis 22. In other embodiments, the fluid-tight containment region 16 is tapered along sidewall 63 such that the cross-sectional area of the fluid-tight containment region 16 increases along the optical axis 22 in the direction from the first window 26 to the second window 32 or sidewall 63 is non-tapered such that the cross-sectional area of the fluid-tight containment region 16 remains substantially constant along the optical axis 22.

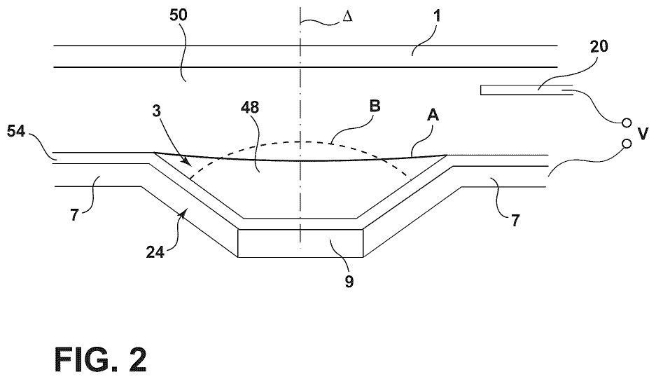

An optical lens driven by electrowetting and of variable focal length is depicted in exemplary form in FIG. 2. A cell is defined by a fluid chamber comprising a lower plate and an upper plate 1, and a perpendicular (normal to), or substantially perpendicular (normal to), axis Δ. The lower plate includes a conductive body 7 and a transparent window 9, as will be discussed further herein. The lower plate, which is non-planar, includes a conical or cylindrical depression or recess 3, which contains a non-conductive or insulating fluid, such as the first liquid 48. The remainder of the cell is filled with an electrically displaceable conductive fluid, such as the second liquid 50, along the axis Δ.

As mentioned above, the first and second liquids 48, 50 are non-miscible. The first and second liquids 48, 50 are in contact over a meniscus (A, B), have a different refractive index, and substantially the same density. The cell includes the insulating layer 54, arranged on at least an area of the lower plate, on which the first and second liquids 48, 50 are in contact.

In the example of FIG. 2, the insulating layer 54 covers the entire lower plate, but it may be limited to an area of the lower plate on which the first and second liquids 48, 50 are in contact. The second electrode 24 is separated from the first and second liquids 48, 50 by the insulating layer 54. In this example, the lower plate includes the conductive body 7 acting as the second electrode 24 and the transparent window 9 for the passage of a beam of light. The conductive body 7 in FIG. 2 is used for the centering of the second liquid 50. The first electrode 20 is in contact with the second liquid 50. The wettability of the insulating layer 54 by the second liquid 50 varies under the application of a voltage V between the first and the second electrodes 20, 24, such that, through electrowetting phenomena, it is possible to modify the shape of the meniscus, depending on the voltage V applied between the electrodes. Thus, a beam of light passing through the cell normal to the plates in the region of the drop will be focused to a greater or lesser extent according to the voltage applied. Voltage V may be increased from 0 volt to a maximum voltage, which depends on the used materials. For example, when the voltage increases, the first liquid 48 (e.g., a non-conducting liquid drop) deforms to reach a limiting position (designated as B). While the first liquid 48 deforms from its position A (rest position, without tension, concave interface with second liquid 50) to its position B (convex interface with second liquid 50), the focus of the liquid lens 10 varies.

In embodiments, the electromagnetic radiation 47 (e.g., one or more of visible light, ultraviolet light, and infrared radiation) enters the liquid lens 10 through the first window 26, is refracted at the interface 52 between the first liquid 48 and the second liquid 50, and exits the liquid lens 10 through the second window 32. In embodiments, as explained, the first substrate 30 and the second substrate 36 are sufficiently transparent to enable transmission of the wavelengths of electromagnetic radiation 47. The electromagnetic radiation 47 exiting the second window 32 can be detected by a sensor (not illustrated).

In some embodiments, either or both of an outer surface 68 of the first substrate 30 and an outer surface 70 of the second substrate 36 are substantially planar. Thus, although the liquid lens 10 can function as a lens (e.g., by refracting the electromagnetic radiation 47 passing through interface 52), the outer surfaces 68, 70 of the liquid lens 10 can be flat as opposed to being curved like outer surfaces of a fixed lens. In other embodiments, either or both of the outer surfaces 68, 70 are curved (e.g., concave or convex).

In embodiments, the liquid lens 10 includes a power source connected to the first electrode 20 and the second electrode 24. In embodiments, although not shown, the first electrode 20 is connected to a ground by a first lead while the second electrode 24 is connected to the power supply by a second lead. In embodiments, although not shown, the first electrode 20 is connected to the power supply by a first lead while the second electrode 24 is connected to a ground by a second lead. As used herein, ground refers to a connection to earth or another large reservoir of charge such as a large conductive body. As used herein, a power source is any device capable of creating an electric potential difference.

Application of an electrical potential difference (referred to herein as an “applied voltage”) between the first electrode 20 and the second electrode 24 from the power source can change the shape of the lens formed by the interface 52 between the first liquid 48 and the second liquid 50. Without wishing to be bound by theory, the lens formed by the interface 52 between the first liquid 48 and the second liquid 50 may be adjusted using the electrowetting phenomena by adjusting the applied voltage between the first electrode 20 and the second electrode 24. In embodiments, adjusting the applied voltage changes the focal length of the lens by altering the shape (e.g. curvature) of interface 52. In one embodiment, a change of focal length can enable liquid lens 10 to perform an autofocus function in an open loop configuration. As used herein, the optical power of a lens is measured using diopters, which is a reciprocal of a focal length of a lens. In some embodiments, the optical power of the liquid lens 10 may be adjusted through application of a voltage between first electrode 20 and second electrode 24 by about 0.25 diopters (D) or more, about 1 D or more, about 2 D or more, about 5 D or more, about 40 D or less, about 30 D or less, about 20 D or less or about 10 D or less. In some embodiments, the optical power of the liquid lens 10 may be adjustable through application of a voltage between first electrode 20 and second electrode 24 in a range from about −30 D to about 40 D, from about −20 D to about 20 D, from about −15 D to about 15 D, from about −10 D to about 10 D, from about −5 D to about 5 D, from about −2 D to about 2 D, from about 0 D to about 20 D, from about 0 D to about 10 D, from about 0 D to about 5 D, from about 0 D to about 2 D, or any range or subrange therebetween.

Additionally, or alternatively, application of a voltage between the first electrode 20 and the second electrode 24 tilts the interface 52 relative to the optical axis 22 of the liquid lens 10. Such tilting can enable the liquid lens 10 to perform an optical image stabilization (“OIS”) function. Adjusting the interface 52 (e.g., tilting, changing the shape of) can be achieved without physical movement of the liquid lens 10 relative to an image sensor, a fixed lens or lens stack, a housing, or other components of a camera module or other module in which the liquid lens 10 can be incorporated.

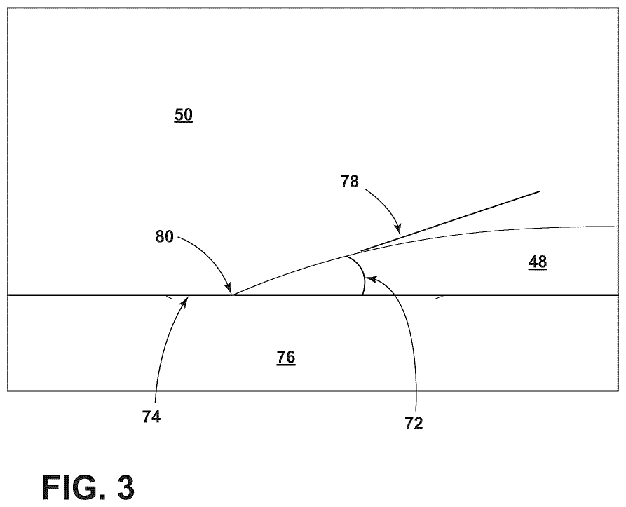

When a voltage is applied between the first electrode 20 and the second electrode 24, the shape or position of interface 52 may vary to alter the focal length of liquid lens 10. In one embodiment, application of a voltage between first electrode 20 and second electrode 24 varies the coverage of first liquid 48 and/or second liquid 50 along sidewall 63 of insulating layer 54. Accordingly, the position of the triple junction 80 (see FIG. 3) of interface 52 along the sidewall 63 of insulating layer 54 may vary and the shape (e.g. curvature) of interface 52 may change in response to an applied voltage. The voltage applied between the first electrode 20 and the second electrode 24 can be adjusted based on the measurement that is indicative of the focus to position the triple junction 80 of interface 52 at a desired location along sidewall 63 (e.g., at a location configured to provide a particular focal length for liquid lens 10). For example, a camera system utilizing liquid lens 10 can provide a command to set liquid lens 10 at a particular focal length. In such an example, an appropriate voltage can be applied between first electrode 20 and second electrode 24 of liquid lens 10 to adjust the position of triple junction 80 along sidewall 63 and/or the shape of interface 52 to achieve the particular focal length. Adjustments of the applied voltage can be made to counteract deviations of the focal length from the intended focal length to provide stable operation of liquid lens 10. The system can make repeated measurements and adjust the applied voltage as necessary to hold the triple junction 80 of the interface 52 at the position along sidewall 63 that provides a particular focal length.

In some embodiments, the dielectric constant of the insulating layer 54 can change as the temperature changes, which can affect the position or shape of interface 52. In some embodiments, the liquid lens 10 can include a temperature sensor configured to measure a temperature in the liquid lens 10. The system can account for the measured temperature when adjusting the voltage applied to the liquid lens 10 based on the measurements relating to the focus of liquid lens 10 or the position or shape of interface 52. In some embodiments, the temperature sensor can be embedded in the liquid lens 10. For example, the temperature sensor can be disposed between two layers of the liquid lens 10 construction. A conductive lead can extend from the embedded location of the temperature sensor to a periphery of the liquid lens 10, such as for providing and/or receiving signals from the temperature sensor. The temperature sensor can include a thermocouple, a resistive temperature device (RTD), a thermistor, an infrared sensor, a bimetallic device, a thermometer, a change of state sensor, a semiconductor-based sensor (e.g., a silicon diode), or another type of temperature sensing device.

In some embodiments, the liquid lens 10 can include a heating element (not shown), which can be used to control the temperature in the fluid-tight containment region 16 of the liquid lens 10. For example, a liquid lens 10 can have a response rate to applied voltage that decreases dramatically when the temperature of liquid lens 10 falls below a threshold temperature (e.g., freezing). In some embodiments, the heating element can be embedded in the liquid lens 10. For example, the heating element can be disposed between two layers of the liquid lens 10 construction. A conductive lead can extend from the embedded location of the heating element to a periphery of the liquid lens 10, such as for providing and/or receiving signals from the heating element. The heating element can include a resistive heater, a capacitive heater, an inductive heater, a convective heater, or another type of heater. The system can operate the heating element based at least in part on signals received from the temperature sensor. The system can measure the temperature and use the heating element to warm the liquid lens if the temperature is below a threshold value. The system can use feedback control to control the temperature using the temperature sensor and the heating element.

In some embodiments, the first electrode 20 can include multiple electrodes positioned at multiple locations on the liquid lens 10. In other embodiments, the first electrode 20 can include various numbers of electrodes (e.g., 1 electrode, 2 electrodes, 4 electrodes, 6 electrodes, 8 electrodes, 12 electrodes, 16 electrodes, or more). In such an example, different ones of the electrodes can be driven independently (e.g., having the same or different voltages applied thereto), which can be used to independently control the position or shape of interface 52 at different azimuthal (orientational) locations within the fluid-tight containment region 16 of the liquid lens 10.

In various examples, first electrode 20 includes multiple electrodes and a different voltage may be applied to different ones of the multiple electrodes such that different portions of the interface 52 are displaced to different degrees from an initial position of interface 52. Selective displacement of different portions of interface 52 along sidewall 63 of insulating layer 54 can cause the optical axis 22 of the liquid lens 10 to tilt, for example, from a direction normal to first substrate 30 and/or second substrate 36 to a direction non-normal to first substrate 30 and/or second substrate 36. This tilt can be used by a camera or imaging system that includes liquid lens 10 to provide optical image stabilization, off-axis focusing, etc. In some cases, first electrode 20 includes multiple electrodes and different voltages can be applied to different ones of the electrodes to compensate for external forces (e.g. bumping or vibration) applied to the liquid lens 10 so that the liquid lens 10 maintains on-axis focusing.

With reference to FIG. 3, the contact angle θ (numerical reference 72) is the angle formed between a tangent 74 to a dielectric enclosure such as in the form of a planar insulating substrate 76 and a tangent 78 to a surface of the first liquid 48, both measured at the point of a triple junction 80 and in the presence of the second liquid 50. When no voltage is applied, the contact angle 72, referred to as θ₍₀₎, relies on the Young equation shown in Equation 1.

γ_{CL-IM}=γ_{NCL-IM}+γ_{NCL-CL} cos θ (Equation 1)

In Equation 1, γ_{CL-IM} is the free energy associated with the interface between the second liquid 50 and the insulating layer 54, γ_{NCL-IM} is the free energy associated with the interface between the first liquid 48 and the insulating layer 54, and γ_{NCL-CL} is the free energy associated with the interface between the first liquid 48 and the second liquid 50. θ_{(V)} is the contact angle of the first liquid 48 on the insulating layer 54 at voltage V. It is understood that a contact angle θstated without reference to a specific voltage refers to the contact angle θ₍₀₎ (i.e. recorded at an applied voltage of zero volts). The contact angle θ₍₀₎ of two immiscible fluids on a solid surface (e.g., the insulating layer 54) is an intrinsic property of the materials and does not depend on the geometry of the device. The contact angle 72 is usually measured on flat substrates at a reference temperature. For example, the reference temperature may be room temperature (e.g., between about 20° C. and about 25° C.). For purposes of the present disclosure, the reference temperature is 22° C. A low contact angle between the first liquid 48 and the insulating layer 54 is necessary to obtain low optical power hysteresis for the liquid lens 10.

A desirable characteristic of electrowetting optical devices, such as liquid lens 10, is a contact angle that is consistent at a selected applied voltage over a cycle of operation of liquid lens 10. In practical applications, liquid lens 10 is operated over multiple cycles of operation in which the applied voltage is increased from a minimum voltage to a maximum voltage and decreased from the maximum voltage back to the minimum voltage. The minimum voltage is typically zero volts (no applied voltage) and the maximum voltage is the highest voltage determined to avoid failure or to prolong the durability of liquid lens 10. During a cycle of operation, applied voltages between the minimum voltage and the maximum voltage are encountered twice—once while increasing the voltage and again while decreasing the voltage. In practical applications, it is desirable for the contact angle to be consistent at a specified applied voltage irrespective of whether the specified applied voltage is established upon increasing or decreasing the applied voltage during a cycle of operation. The difference between the contact angle at a specified applied voltage when increasing applied voltage and the contact angle safe for operation when cycling the applied voltage from a low voltage to a high voltage at a given applied voltage, irrespective of whether the given applied voltage is established by increasing the applied voltage from a voltage below the given applied voltage to the given applied voltage or decreasing the applied voltage from a voltage above the given applied voltage to the given applied voltage. The difference between the contact angle at a specified applied voltage when measured during an increase in applied voltage and the contact angle at the specified applied voltage when measured during a decrease in applied voltage constitutes hysteresis of liquid lens 10 during a cycle of operation. Hysteresis can also be expressed in terms of a difference in a performance attribute of liquid lens 10 that depends on the contact angle (e.g. optical power or focal length of liquid lens 10).

For purposes of the present disclosure, “hysteresis” refers to the difference between the optical power at a specified applied voltage measured while increasing the applied voltage and the optical power at the specified applied voltage measured while decreasing the applied voltage over one cycle of operation. The cycle of operation is defined by an applied AC voltage (1 kHz) that extends from an initial voltage of 0 V (no applied voltage) to a final voltage of 50 V and decreasing the applied AC voltage from the final voltage of 50 V back to the initial voltage of 0 V (no applied voltage). The rate of increase in the voltage of the applied AC voltage from the initial voltage to the final voltage was executed using the following progression: 0 V to 10 V, 10 V to 20 V, and then 20 V to 70 V. The rate of decrease in the voltage of the applied AC voltage from the final voltage to the initial voltage was executed by operating the progression for the increase in reverse. Accordingly, the rate of decrease in the voltage of the applied AC voltage was executed using the following progression: 70 V to 20 V, 20 V to 10 V, and then 10 V to 0 V. Data points between 20 V and 70 V were collected at 2 V intervals in both the increasing voltage progression and the decreasing voltage progression. Accordingly, data points were collected at 0 V, 10 V, 20 V, 22 V, 24 V, 26 V, 28 V, 30 V, 32 V, 34 V, 36 V, 38 V, 40 V, 42 V, 44 V, 46 V, 48 V, 50 V, 52 V, 54 V, 56 V, 58 V, 60 V, 62 V, 64 V, 66 V, 68 V, and 70 V in the increasing voltage progression and the decreasing voltage progression. The data points were collected after a time delay once a given voltage was reached. The time delay between reaching the given voltage and recording the given voltage was 200 milliseconds (0.200 s). The specified applied voltage at which optical power was measured is 50 V.

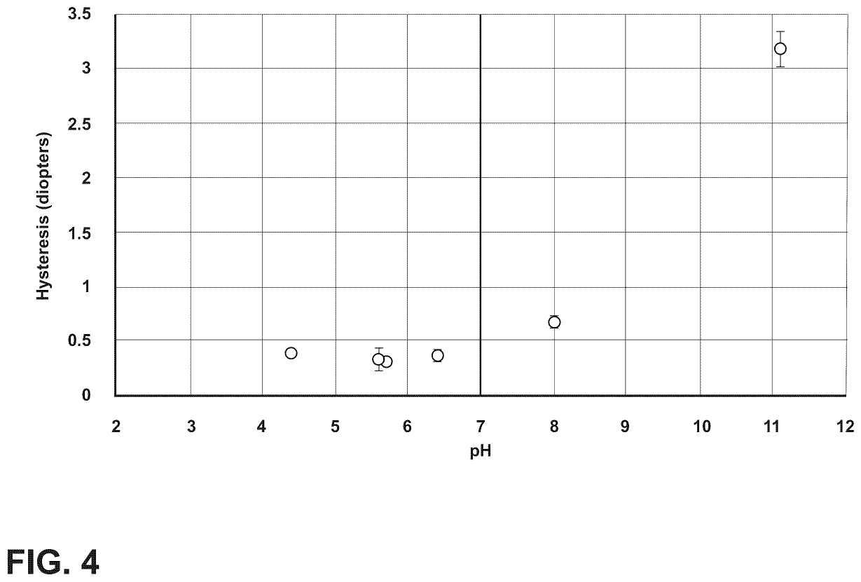

FIG. 4 depicts the hysteresis, in diopters, of a liquid lens 10 in accordance with the present disclosure as a function of the pH of the second liquid 50. The data points shown in FIG. 4 for the hysteresis of the liquid lens 10 correspond with Examples 1-6 that are discussed in further detail herein. As seen in FIG. 4, the hysteresis of the liquid lens 10 decreased significantly when reducing the pH of second liquid 50. High hysteresis was observed when second liquid 50 had high pH and the hysteresis decreased as the pH was reduced. In particular, as second liquid 50 became acidic (pH<7.0), low hysteresis was observed. More specifically, the liquid lens of this example exhibited a hysteresis of less than about 0.50 diopter when the pH of second liquid 50 was below 7.0.

Optical power drift refers to a time variation in optical power of a liquid lens upon application of an applied voltage between electrodes 20 and 24. Optical power drift is a measurement of optical power upon application of an applied voltage relative to the optical power of the liquid lens when no voltage is applied. Optical power increases with increasing applied voltage. For purposes of the present disclosure, an applied voltage of 50 V (AC at a frequency of 5 kHz) is used to measure optical power drift.

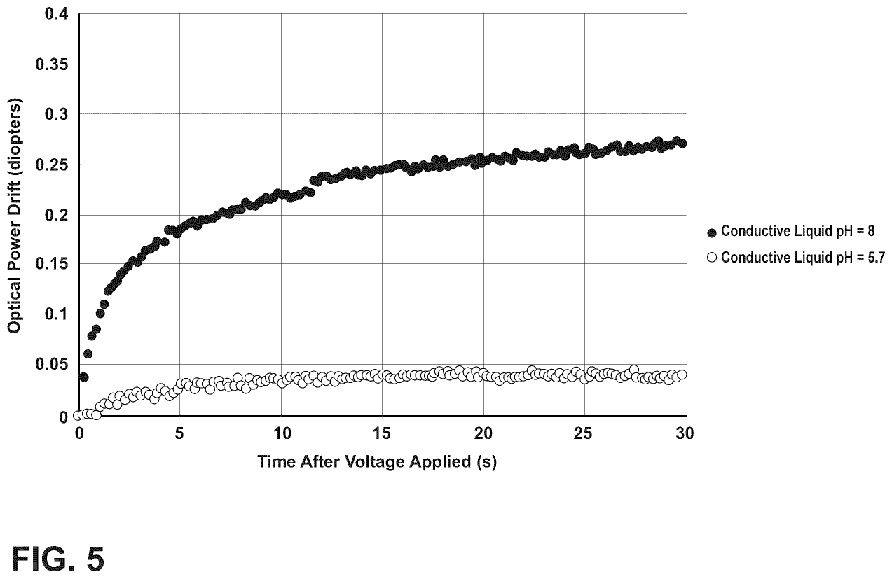

FIG. 5 shows the effect of the pH of second liquid 50 on optical power drift of a liquid lens device. The liquid lens device consisted of an A25H0 Corning Varioptic lens package with a clear aperture of 2.5 mm, an outer diameter of the liquid lens device was 7.75 mm, and a total thickness of the liquid lens device was 2.1 mm. A volume of the first liquid 48 within the liquid lens 10 was about 2.1 microliters (μL). A volume of the second liquid 50 within the liquid lens 10 was a volume sufficient to fill a remaining volume of the fluid-tight containment region 16. Except for the presence of the buffer in the second liquid 50 used to control pH to 5.7, the liquid lens devices corresponding to the data curves in FIG. 5 were identical. More specifically, the conductive liquid with a pH of 8 contained ethylene glycol, water, and potassium acetate, while the conductive liquid with a pH of 5.7 contained ethylene glycol, water, potassium acetate, and acetic acid. The non-conductive liquid used with the pH of 8 conductive liquid and the non-conductive liquid used with the pH of 5.7 conductive liquid were identical. More specifically, the non-conductive liquid contained hexaethyldigermane, hexamethyldigermane, n-octyltris(trimethylsiloxy)silane, and diphenydimethylgermane. The dielectric topcoat used in the examples depicted in FIG. 5 were formed from an organosilicon precursor through a plasma deposition process (e.g., PECVD). The data shown in FIG. 5 were collected by applying an AC voltage of 50 volts to the liquid lens 10. The frequency of the AC voltage was 5 kHz.

The data in FIG. 5 indicate that a reduction in pH of second liquid 50 leads to a reduction in optical power drift. After application of the applied voltage for 30 s, optical power drift was about 0.27 diopters in the liquid lens device with second liquid 50 having a pH of 8. When second liquid 50 had a pH of 5.7, the optical power drift was less than 0.05 diopters. The reduction in pH also reduced the time needed to reach a steady state in optical power drift. When second liquid 50 had a pH of 5.7, the optical power drift stabilized at or before 15 s. When second liquid 50 had a pH of 8, the optical power drift was still increasing and not yet stabilized at a time of 30 s.

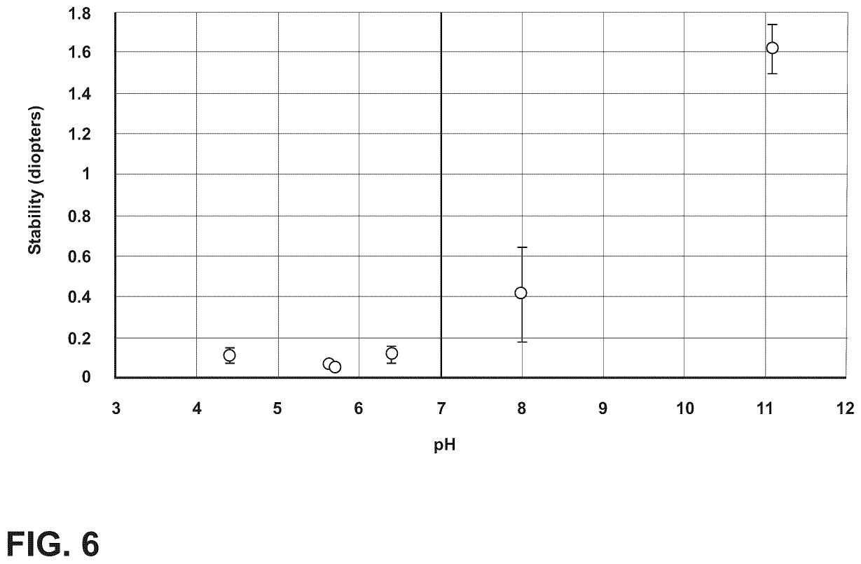

FIG. 6 depicts the stability, in diopters, of the liquid lens 10 as a function of the pH of the second liquid 50. The physical structure and arrangement of the liquid lens 10 from which the data in FIG. 6 was obtained is the same as the liquid lens 10 discussed with regard to FIG. 5. Stability is defined as the optical power drift at steady state following application of the applied voltage (50 V AC at 5 kHz). More specifically, the stability was evaluated by increasing the applied voltage from 0 V to 10 V and finally to the final applied voltage of 50 V. Accordingly, the liquid lens 10 was increased from an initial voltage of 0 V to an intermediate voltage of 10 V. After reaching the intermediate voltage of 10 V, the applied voltage was increased to the final voltage of 50 V. Once the liquid lens 10 reached the applied voltage of 50 V, the voltage was maintained for 15 s or 30 s, depending on a given experiment.

As shown in FIG. 6, as the pH of the second liquid 50 decreases, the stability of the liquid lens 10 improves. For example, at a pH of slightly above 11, the liquid lens 10 exhibited a stability of about 1.6 diopters. At a pH of about 8.0, the second liquid 50 exhibited a stability of about 0.40 diopters. However, when the pH of the second liquid 50 was lowered to within an acidic range, the liquid lens 10 exhibited a stability of 0.20 diopters or less.

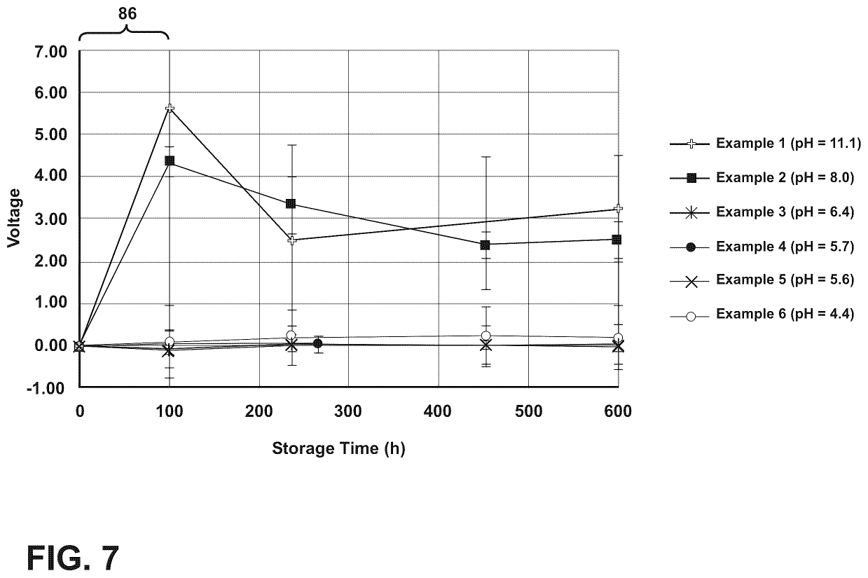

FIG. 7 depicts a thermal stability of the liquid lens 10 as a function of storage time. More specifically, six exemplary liquid lenses were studied, where a pH of the second liquid 50 within the liquid lens 10 was varied. The liquid lens device used in each of the experiments shown in FIG. 7 was an A25H0 Corning Varioptic lens package with a clear aperture of 2.5 mm, an outer diameter of the liquid lens device was 7.75 mm, and a total thickness of the liquid lens device was 2.1 mm. The insulating layer 54 of the liquid lens 10 was parylene C with an additional topcoat of the organosilicon precursor deposited by PECVD. The steady state optical power of each liquid lens 10 was measured prior to storage and the effect of storage at high temperature on optical power was determined for each liquid lens 10. FIG. 7 shows the applied voltage (AC, 5 kHz) needed to reverse the optical power drift resulting from storage and restore the initial optical power of each liquid lens 10, each as a function of storage time. Each of the liquid lenses was initially stored in air at a temperature of 105° C. for a period of 100 hours, as indicated by bracket 86. Each of the six exemplary liquid lenses was then removed from the 105° C. storage environment, cooled to room temperature, and maintained at room temperature (e.g., between about 20° C. and about 25° C.) for an additional time of 500 hours. Accordingly, the total storage time for each of the six exemplary liquid lenses was 600 hours, as shown on the x-axis of FIG. 7. It is noted that similar results were observed with a lower initial thermal storage temperature (e.g., 85° C.) and additional storage time (>500 hours) at room temperature. However, the phenomenon (thermally induced optical drift) requires a longer storage time at the lower initial thermal storage temperature (e.g., 500 hours at 85° C. instead of 100 hours at 105° C.). In such a case, the drift observed at room temperature required more time to appear.

Each of the six exemplary liquid lenses was evaluated at four time points. The four time points were 100 hours (immediately after the initial storage at 105° C.), 236 hours, 452 hours, and at 600 hours, as shown in FIG. 7. Example 1 was a liquid lens with a conductive liquid having a pH of about 11.1. More specifically, the composition of the conductive liquid of Example 1, in weight percent, was 96.65% ethylene glycol, 3.00% water, 0.21% potassium phosphate tribasic, and 0.14% sodium phosphate dibasic. Characteristics of the conductive liquid of Example 1 at 20° C. include, but are not limited to, a pH of 11.1, a refractive index n_{d} of 1.4295, a density of 1.1126 g/cm³, and a viscosity of 17.51 mm²/s. Example 2 was a liquid lens with a conductive liquid having a pH of about 8.0. More specifically, the composition of the conductive liquid of Example 2, in weight percent, was 92.80% ethylene glycol, 4.20% potassium acetate, and 3.00% water. Characteristics of the conductive liquid of Example 2 include, but are not limited to, a pH of 8.0, a refractive index n_{d} of 1.4300, a density of 1.1256 g/cm³, and a viscosity of 19.30 mm²/s. The conductive liquid of Example 2 was not buffered.

Example 3 was a liquid lens with a conductive liquid having a pH of about 6.4. More specifically, the composition of the conductive liquid of Example 3, in weight percent, was 96.64% ethylene glycol, 3.00% water, 0.24% disodium succinate, and 0.12% succinic acid. Characteristics of the conductive liquid of Example 3 include, but are not limited to, a pH of 6.4, a refractive index n_{d} of 1.4294, a density of 1.1100 g/cm³, and a viscosity of 17.28 mm²/s. Example 4 was a liquid lens with a conductive liquid having a pH of about 5.7. More specifically, the composition of the conductive liquid of Example 4, in weight percent, was 96.82% ethylene glycol, 3.00% water, 0.10% potassium acetate, and 0.08% acetic acid. Characteristics of the conductive liquid of Example 4 include, but are not limited to, a pH of 5.7, a refractive index n_{d} of 1.4292, a density of 1.1087 g/cm³, and a viscosity of 16.92 mm²/s.

Example 5 was a liquid lens with a conductive liquid having a pH of about 5.6. More specifically, the composition of the conductive liquid of Example 5, in weight percent, was 96.80% ethylene glycol, 3.00% water, 0.12% succinic acid, and 0.08% disodium succinate. Characteristics of the conductive liquid of Example 5 include, but are not limited to, a pH of 5.6, a refractive index n_{d} of 1.4293, a density of 1.1100 g/cm³, and a viscosity of 17.10 mm²/s. Example 6 was a liquid lens with a conductive liquid having a pH of about 4.4. More specifically, the composition of the conductive liquid of Example 6, in weight percent, was 96.50% ethylene glycol, 3.00% water, 0.31% potassium citrate, and 0.19% citric acid. Characteristics of the conductive liquid of Example 6 include, but are not limited to, a pH of 4.4, a refractive index n_{d} of 1.4293, a density of 1.1100 g/cm³, and a viscosity of 17.15 mm²/s.

As seen in FIG. 7, the exemplary liquid lenses that employed conductive liquids having a basic pH required greater applied voltages after storage to establish an optical power of zero diopter. For example, Example 1 (pH =11.1) required an applied voltage of between 2.00 volts and 6.00 volts to establish an optical power of zero diopter and Example 2 (pH=8.0) required an applied voltage of between 2.00 volts and 5.00 volts to establish an optical power of zero diopter. By contrast, Examples 3-6, each of which was provided with a conductive liquid having an acidic pH, required an applied voltage of between −1.00 volts and 1.00 volts to establish an optical power of zero diopter. Therefore, an increased stability of the operating voltage following storage has been observed in liquid lenses 10 using a conductive liquid that has been buffered to an acidic pH. More specifically, with the conductive liquids of the present disclosure that have been buffered to an acidic pH, the voltage applied to obtain an optical power of zero diopter is the same before storage and after storage. By contrast, the voltage applied to obtain an optical power of zero diopter varies as a function of storage time for the conductive liquids that are operated at a basic pH. In various applications of the liquid lenses 10 of the present disclosure, the second liquid 50 of Example 4 that employed a buffer based on acetic acid as the weak acid and acetate as the conjugate base may be preferable.

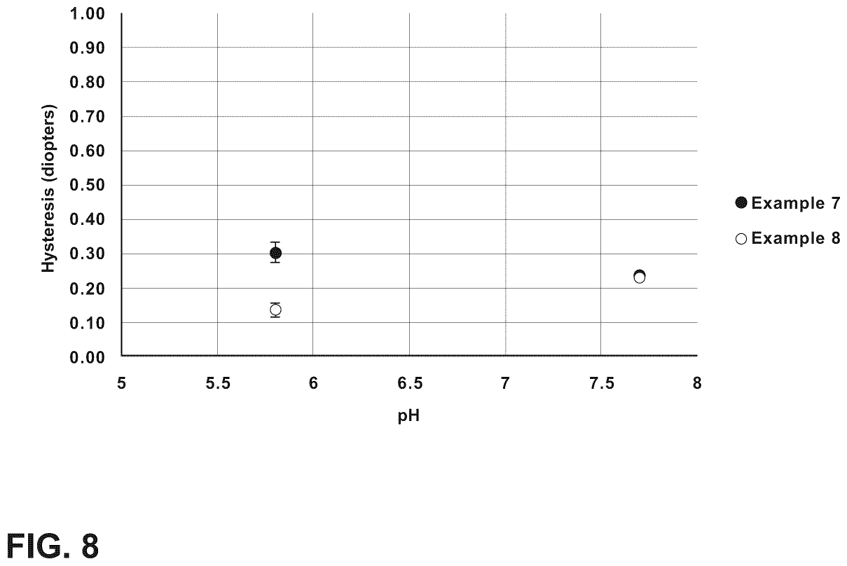

Referring now to FIGS. 8-10, additional examples of liquid lens 10 were prepared and evaluated. The liquid lens device used in each of the experiments shown in FIGS. 8-10 was an A25H0 Corning Varioptic lens package with a clear aperture of 2.5 mm, an outer diameter of the liquid lens device was 7.75 mm, and a total thickness of the liquid lens device was 2.1 mm. For Example 7, the base layer of insulating layer 54 was parylene C and no dielectric topcoat was applied. For Example 8, the insulating layer 54 was a bilayer that included a base layer of parylene C (99 wt %) and a dielectric topcoat of Teflon™ AF 1600 (1 wt %). The dielectric topcoat Teflon™ AF 1600 was deposited directly on the base layer of parylene C by spin coating. The dielectric topcoat Teflon™ AF 1600 was in direct contact with the liquids in the liquid lens of Example 8. Except for the composition of insulating layer 54, the device structure of the liquid lenses used in Examples 7 and 8 were identical.

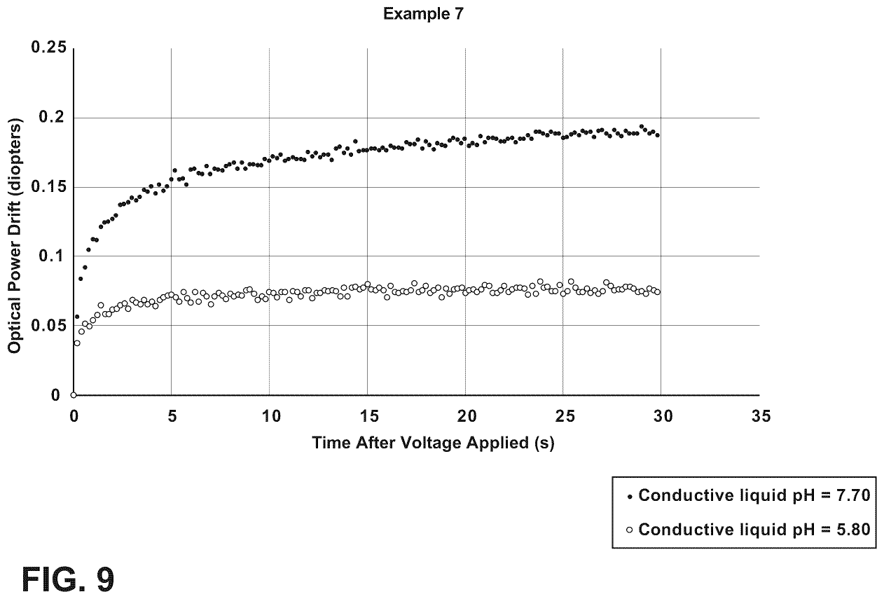

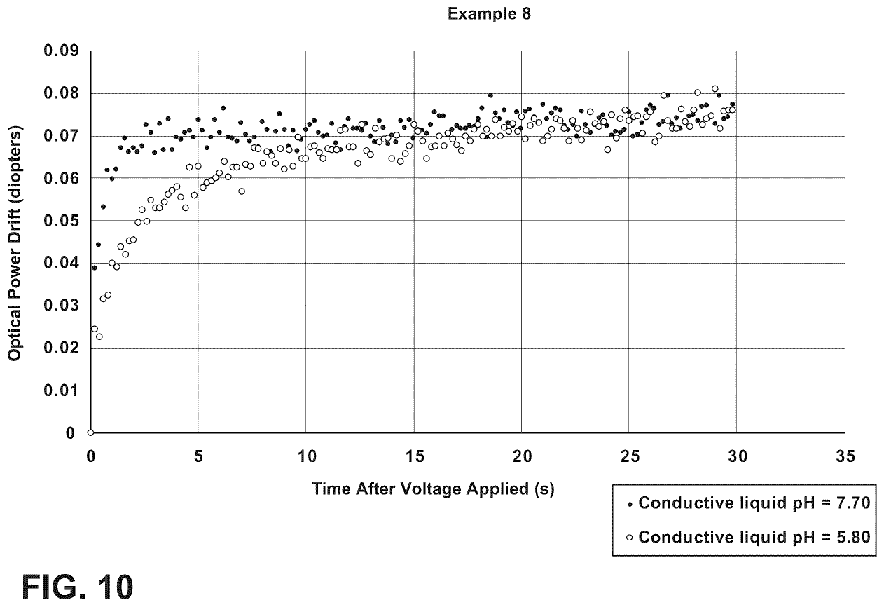

Hysteresis was evaluated for the liquid lenses of Examples 7 and 8. Two trials for the liquid lens of each of Examples 7 and 8 were completed. In all trials, the same first liquid 48 was used. The composition (in weight percent (wt %)) of the first liquid 48 was 75% phenyltrimethylgermane and 25% phenyltris(trimethylsiloxy)silane. Different second liquids 50 were used in two separate trials for each of Examples 7 and 8. In a first trial, see filled circles in FIGS. 9 and 10, an unbuffered second liquid 50 was used. The unbuffered second liquid 50 had the composition (wt %) 50% water, 49% ethylene glycol, and 1.0% potassium acetate. The unbuffered second liquid 50 had a pH of 7.70. In a second trial, see unfilled circles in FIGS. 9 and 10, a buffered second liquid 50 was used. The buffered second liquid 50 had a composition (wt %) of 49.82% water, 50% ethylene glycol, 0.1% potassium acetate, and 0.08% acetic acid. Buffering was provided by the acetic acid and its conjugate base (acetate ion). The buffered second liquid 50 had a pH of 5.80.

FIG. 8 shows the hysteresis for each trial of the liquid lenses used in Example 7 and Example 8. A hysteresis of about 0.25 diopters was observed in the trials of Examples 7 and 8 when using the unbuffered second liquid 50. Different results were observed in the trials of Examples 7 and 8 in which the buffered second liquid 50 was used. In Example 7, use of the buffered second liquid 50 led to an increase in hysteresis (to about 0.30 diopters). In Example 8, in contrast, use of the buffered second liquid 50 led to a decrease in hysteresis (to about 0.14 diopters).

FIGS. 9 and 10 are graphs that depict the optical power drift, in diopters, for the two trials of Example 7 and 8, respectively. In FIGS. 9 and 10, the buffered second liquid 50 is referred to as “Conductive Liquid pH=5.80” and the unbuffered second liquid 50 is referred to as “Conductive Liquid pH=7.70”. As can be seen in FIG. 9, the liquid lens of Example 7 showed a decrease in the optical power drift when comparing the buffered second liquid 50 to the unbuffered second liquid 50. Accordingly, the liquid lens of Example 7 exhibited improvements in both hysteresis and optical drift when using the buffered second liquid 50 instead of the unbuffered second liquid 50. However, as shown in FIG. 10, the liquid lens of Example 8 showed no improvement in optical power drift when using a buffered second liquid 50 instead of an unbuffered second liquid 50.

As shown by the data discussed above, the liquid lenses 10 of the present disclosure exhibit good optical quality, exhibit a low optical power shift when a voltage is applied, provide stable optical performance over time, and prevent an increase of hysteresis after storage.

In various examples of the present disclosure, in an effort to maintain a desired pH of the second liquid 50 over time, the second liquid 50 of the liquid lens 10 can be buffered to an acidic pH. Buffering is achieved by including an acid and its conjugate base in the second liquid 50. The conjugate base is typically added in the form of a salt. As is known in the art, the pH of a buffered solution, such as the second liquid 50, can be controlled by varying the proportions of the acid and its conjugate base. Suitable acids include strong acids, weak acids, inorganic acids, and organic acids. Preferred acids are weak acids and more preferably, the weak acid is an organic acid. In addition to an acid and its conjugate base, second liquid 50 includes a polar liquid such as water or ethylene glycol. The polar liquid may act as a solvent for the acid and/or conjugate base. In some embodiments, second liquid 50 includes one or more salts in addition to the salt used to provide the conjugate base of the acid used to form the buffer.

In embodiments, the second liquid 50 can be buffered to a pH of less than 7.0. In some examples, the pH to which the second liquid 50 is buffered can be about 6.5, about 6.0, about 5.5, about 5.0, about 4.5, about 4.0, about 3.5, about 3.0, about 2.5, about 2.0, about 1.5, about 1.0, about 0.5, and/or combinations or ranges thereof. In one specific example, the pH to which the second liquid 50 is buffered to can be in a range of about 3.0 to less than about 7.0. In some examples, the acid and the conjugate base may each be present in the second liquid 50 at a concentration of between about 0.0010 moles per liter (mol/L) and about 1.0 moles per liter (mol/L).

In one specific example, the weak acid is succinic acid and the conjugate base is succinate ion, provided, for example, in the form of disodium succinate. In such an example, the succinic acid can be present at a concentration of about 0.12% by weight of the second liquid 50. Additionally, in such an example, the disodium succinate can be present at a concentration of about 0.080% by weight of the second liquid 50. Ethylene glycol can be present within the second liquid 50 at a concentration of greater than about 96% by weight of the second liquid 50. Water can be present within the second liquid 50 at a concentration of at least about 3.0% by weight of the second liquid 50.

In another specific example, the weak acid in the second liquid 50 can be citric acid and the conjugate base can be potassium citrate. In such an example, the citric acid can be present within the second liquid 50 at a concentration of about 0.20% by weight of the second liquid 50. Additionally, in such an example, the potassium citrate can be present within the second liquid 50 at a concentration of about 0.30% by weight of the second liquid 50. Ethylene glycol can be present within the second liquid 50 at a concentration of greater than about 96% by weight of the second liquid 50. Water can be present within the second liquid 50 at a concentration of at least about 3.0% by weight of the second liquid 50.

In various examples of the present disclosure, the first liquid 48 can include hexaethyldigermane, hexamethyldigermane, n-octyltris(trimethylsiloxy)silane, and/or diphenyldimethylgermane. In one specific example, the first liquid 48 can include hexaethyldigermane at a concentration of about 59% by weight of the first liquid 48, hexamethyldigermane at a concentration of about 25% by weight of the first liquid 48, n-octyltris(trimethylsiloxy)silane at a concentration of about 9.0% by weight of the first liquid 48, and diphenyldimethylgermane at a concentration of about 7.0% by weight of the first liquid 48.

An alternative composition of the first liquid 48 can include 50.0% phenyltrimethylgermane, 25.0% hexamethyldigermanium, 15.0% diphenyldimethylgermane, and 10.0% polydimethylsiloxane, trimethylsiloxy terminated. Another alternative composition of the first liquid 48 can include 80.0% hexaethyldigermane and 20.0% tetraallylgermane. Another alternative composition of the first liquid 48 can include 50.0% hexamethyldigermanium, 35.0% triethylphenylgermane, and 15.0% diphenyldimethylsilane.

It will be apparent to those skilled in the art that various modifications and variations can be made without departing from the spirit or scope of the claims.

What is claimed is:

1. An electrowetting optical device, comprising:
a conductive liquid comprising a buffer, the buffer comprising an acid and a conjugate base of the acid, the buffer controlling the pH of the conductive liquid to a predetermined pH;
a non-conductive liquid, the non-conductive liquid immiscible with the conductive liquid; and
an insulating layer comprising a base layer and a dielectric topcoat, the dielectric topcoat in direct contact with the conductive liquid and the non-conductive liquid.

2. The electrowetting optical device of claim 1, wherein the predetermined pH is less than 7.0.

3. The electrowetting optical device of claim 2, wherein the predetermined pH is greater than 3.0.

4. The electrowetting optical device of claim 1, wherein the conductive liquid and the non-conductive liquid form a triple junction on the dielectric topcoat.

5. The electrowetting optical device of claim 4, wherein the acid is succinic acid.

6. The electrowetting optical device of claim 5, wherein the conductive liquid further comprises disodium succinate.

7. The electrowetting optical device of claim 1, wherein the conductive liquid further comprises ethylene glycol at a concentration of greater than about 96% by weight and water at a concentration of at least about 3.0% by weight.

8. The electrowetting optical device of claim 1, wherein the non-conductive liquid comprises one or more of hexaethyldigermane, hexamethyldigermane, n-octyltris(trimethylsiloxy)silane, and diphenyldimethylgermane.

9. The electrowetting optical device of claim 8, wherein the non-conductive liquid comprises two or more of hexaethyldigermane, hexamethyldigermane, n-octyltris(trimethylsiloxy)silane, and diphenyldimethylgermane.

10. The electrowetting optical device of claim 4, wherein the acid is citric acid.

11. The electrowetting optical device of claim 10, wherein the conductive liquid further comprises potassium citrate.

12. The electrowetting optical device of claim 4, wherein the acid is acetic acid.

13. The electrowetting optical device of claim 12, wherein the conductive liquid further comprises potassium acetate.

14. The electrowetting optical device of claim 4, wherein the acid and the conjugate base are each present in the conductive liquid at a concentration of between about 0.0010 mol/L and about 1.0 mol/L.

15. The electrowetting optical device of claim 1, wherein the electrowetting optical device exhibits an optical power drift of less than about 0.040 diopter after a voltage of 50 volts has been applied for 10 seconds.

16. The electrowetting optical device of claim 1, wherein the electrowetting optical device exhibits a hysteresis of less than about 0.50 diopter.

17. The electrowetting optical device of claim 1, wherein the dielectric topcoat is hydrophobic.

18. The electrowetting optical device of claim 1, wherein the dielectric topcoat comprises Si.

19. The electrowetting optical device of claim 18, wherein the dielectric topcoat further comprises C.

20. The electrowetting optical device of claim 19, wherein the dielectric topcoat further comprises H.

21. The electrowetting optical device of claim 1, wherein the dielectric topcoat comprises Si, C, O, and H.

22. The electrowetting optical device of claim 1, wherein the electrowetting optical device is a liquid lens.

23. The electrowetting optical device of claim 1, further comprising a first electrode in direct contact with the conductive liquid and a second electrode in direct contact with the non-conductive liquid.

24. An electrowetting optical device, comprising:
a conductive liquid comprising a buffer, the buffer comprising an acid and a conjugate base of the acid, the buffer controlling the pH of the conductive liquid to a predetermined pH, the predetermined pH in a range from 3.0 to 7.0, the acid and the conjugate base each present in the conductive liquid at a concentration of between 0.0010 mol/L and 1.0 mol/L;
a non-conductive liquid, the non-conductive liquid immiscible with the conductive liquid, the non-conductive liquid and conductive liquid forming a triple junction on the dielectric topcoat; and
an insulating layer comprising a base layer and a dielectric topcoat, the dielectric topcoat in direct contact with the conductive liquid and the non-conductive liquid, the dielectric topcoat comprising SiOₓC_{y}H_{z}.

25. The electrowetting optical device of claim 24, wherein the acid is succinic acid, citric acid, or acetic acid.

26. The electrowetting optical device of claim 25, wherein the conductive liquid further comprises ethylene glycol at a concentration of greater than about 96% by weight and water at a concentration of at least about 3.0% by weight.

27. The electrowetting optical device of claim 26, wherein the non-conductive liquid comprises one or more of hexaethyldigermane, hexamethyldigermane, n-octyltris(trimethylsiloxy)silane, and diphenyldimethylgermane.
